(19) United States
(12) Patent Application Publication
(10) Pub. No.: US 2022/0215677 A1
(43) Pub. Date: Jul. 7, 2022

(54) INFORMATION PROCESSING DEVICE, INFORMATION PROCESSING METHOD, AND PROGRAM

(71) Applicant: SONY GROUP CORPORATION, Tokyo (JP)

(72) Inventors: YOHSUKE KAJI, TOKYO (JP); TOMOYA ISHIKAWA, TOKYO (JP); GAKU NARITA, TOKYO (JP); TAKASHI SENO, TOKYO (JP)

(21) Appl. No.: 17/614,161

(22) PCT Filed: May 29, 2020
(86) PCT No.: PCT/JP2020/021492

§ 371 Date: Nov. 24, 2021

(30) Foreign Application Priority Data
Jun. 6, 2019 (JP) 2019-105967

(51) Int. Cl. G06V 20/64; G06T 19/00; G06F 3/0481

(52) U.S. Cl. CPC G06V 20/64; G06F 3/0481; G06T 19/006

(57) ABSTRACT

An information processing device (30) includes: an estimation unit (325) that estimates an operable part among a plurality of parts of a first object obtained by capturing a real item into a virtual space; and a display control unit (326) that controls a display device (20) to display a motion of the part operated by a second object indicating a virtual item on the basis of operation information of the second object with respect to the first object and a first piece of information indicating a result of the estimation unit (325).

### FIELD

The present disclosure relates to an information processing device, an information processing method, and a program.

### BACKGROUND

Patent Literature 1 discloses technology of acquiring a three-dimensional object model corresponding to text display from a three-dimensional object model database and modifying the shape of the three-dimensional object model on the basis of an attribute value identified by a text analysis unit.

### CITATION LIST

### Patent Literature

Patent Literature 1: Japanese Patent No. 5908855

### SUMMARY

### Technical Problem

In the above conventional technology, in some cases the reality environment, which has been measured, is captured in virtual reality (VR), and an image in which an object is synthesized with the virtual reality is provided to a user. However, in the related art, in a case where information of an item lost in the measurement of the reality environment cannot be reflected in the virtual reality, the item captured in the virtual reality cannot be moved, and the reality of the item is deteriorated. For this reason, conventional virtual reality is desired to improve the reality of a captured item.

Therefore, the present disclosure provides an information processing device, an information processing method, and a program capable of enabling an operation on an object obtained by capturing a real item in virtual reality.

### Solution to Problem

To solve the problems described above, an information processing device according to an embodiment of the present disclosure includes: an estimation unit that estimates an operable part among a plurality of parts of a first object obtained by capturing a real item into a virtual space; and a display control unit that controls a display device so as to display a motion of the part operated by a second object indicating a virtual item on a basis of operation information of the second object with respect to the first object and a first piece of information indicating a result of the estimation unit.

Moreover, an information processing method according to an embodiment of the present disclosure, by a computer, includes the steps of: estimating an operable part among a plurality of parts of a first object obtained by capturing a real item into a virtual space; and controlling a display device so as to display a motion of the part operated by a second object indicating a virtual item on a basis of operation information of the second object with respect to the first object and a first piece of information indicating a result of the estimation.

Moreover, a program according to an embodiment of the present disclosure causes a computer to execute the steps of: estimating an operable part among a plurality of parts of a first object obtained by capturing a real item into a virtual space; and controlling a display device so as to display a motion of the part operated by a second object indicating a virtual item on a basis of operation information of the second object with respect to the first object and a first piece of information indicating a result of the estimation.

### BRIEF DESCRIPTION OF DRAWINGS

FIG. 1 is a diagram illustrating an example of a configuration of a display system including an information processing device according to an embodiment.

FIG. 2 is a diagram for explaining an example of an outline of the information processing device according to the embodiment.

FIG. 3 is a flowchart illustrating an example of a processing procedure executed by the information processing device according to the embodiment.

FIG. 4 is a diagram for explaining an example in which the information processing device recognizes the structure of an item.

FIG. 5 is a diagram for explaining an example in which the information processing device recognizes the structure of another item.

FIG. 6 is a diagram for explaining an example in which the information processing device estimates an operable part of an item object.

FIG. 7 is a diagram for explaining an example in which the information processing device estimates an operable part of another item object.

FIG. 8 is a flowchart illustrating an example of a processing procedure regarding an operation of an object of the information processing device according to the embodiment.

FIG. 9 is a flowchart illustrating another example of a processing procedure regarding an operation of an object of the information processing device according to the embodiment.

FIG. 10 is a flowchart illustrating another example of a processing procedure regarding an operation of an object of the information processing device according to the embodiment.

FIG. 11 is a diagram illustrating an estimation example of an operable part of an item object of an information processing device according to a first modification of the embodiment.

FIG. 12 is a table illustrating examples of operation modes of item objects of an information processing device according to a second modification of the embodiment.

FIG. 13 is a hardware configuration diagram illustrating an example of a computer that implements functions of an information processing device.

### DESCRIPTION OF EMBODIMENTS

Hereinafter, embodiments of the present disclosure will be described in detail on the basis of the drawings. Note that in each of the following embodiments, the same parts are denoted by the same symbols, and redundant description will be omitted.

### EMBODIMENTS

### Outline of Display System According to Embodiment

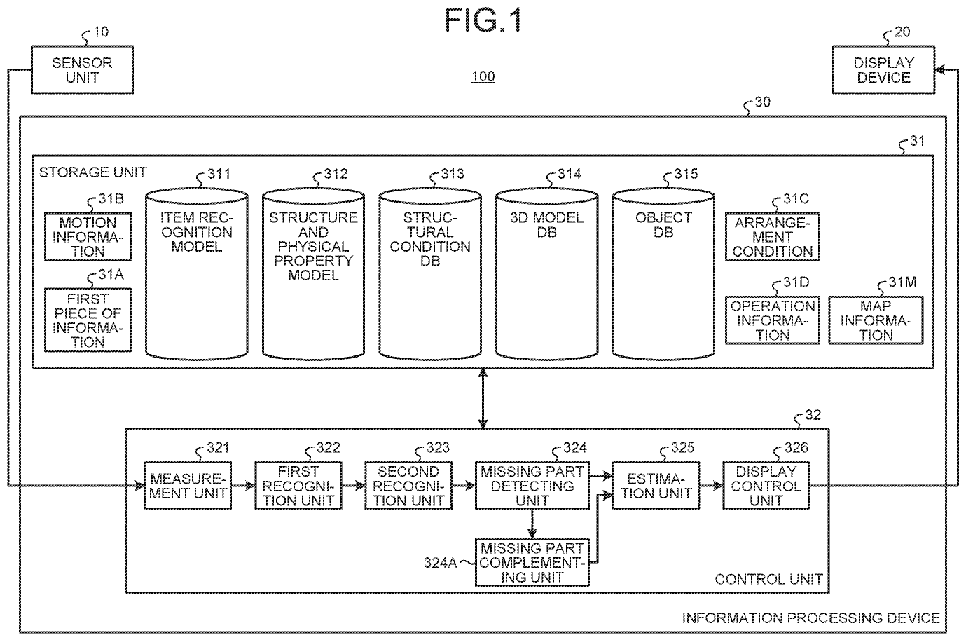

FIG. 1 is a diagram illustrating an example of a configuration of a display system including an information processing device according to an embodiment. A display system 100 illustrated in FIG. 1 includes, for example, a head mounted display (HMD), a smartphone, a game machine, or the like. The display system 100 provides a user with an image of virtual reality (VR), live-action VR, augmented reality (AR), or the like, for example. An image includes, for example, a moving image, a still image, and the like. In the following description, an example of a case where the display system 100 provides a live-action VR image to a user will be described. For example, the live-action VR captures a reality environment into a virtual space by measurement and provides a three-dimensional image in which an object is synthesized with the virtual space.

In the live-action VR, if information such as the mass, the rigidity, and a part of an item is lost when a reality environment is measured, there is a possibility that a gap occurs between an object to be synthesized in a virtual reality and an actual item that has been measured. The reality environment is, for example, a reality environment to be reproduced as a virtual space. For example, in a case where an object is caused to sit on a chair captured in a virtual space, conventional live-action VRs cannot provide an image of reclining the chair or the like when the object leans on a backrest after being caused to sit on the chair due to a missing part of information captured in the virtual space. For this reason, in the conventional live-action VRs, it is desired to improve the reality of an object obtained by capturing in the virtual space.

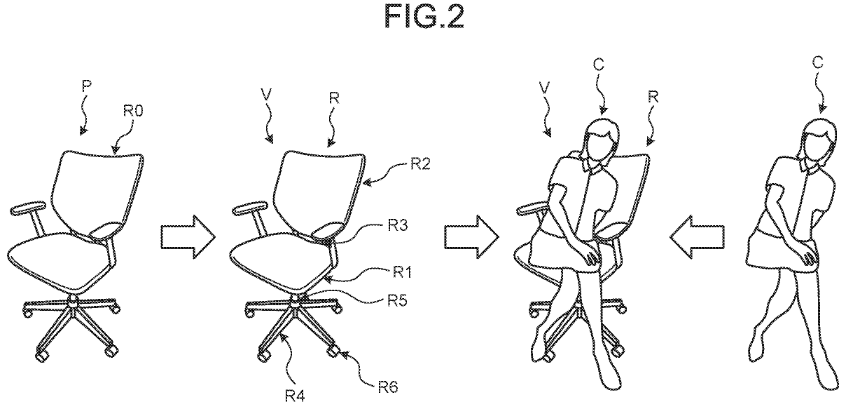

FIG. 2 is a diagram for describing an example of an outline of an information processing device 30 according to the embodiment. In the example illustrated in FIG. 2, the information processing device 30 captures an item RO into a virtual space V as an item object R from information obtained by measuring the item RO in a reality environment P. The item object R is an example of a first object. The information processing device 30 recognizes parts R1, R2, R3, R4, R5, and R6, functions, and the like of the item object R using machine learning or the like. The part R1 is a seat. The part R2 is a backrest. The parts R3 and R5 are joints. The parts R4 are legs. The parts R6 are wheels. The information processing device 30 estimates that the part R2, which is a backrest, can be inclined backward by the part R3, which is a joint. The information processing device 30 estimates that the part R1, which is a seat, can be rotated by the part R5, which is a joint. The information processing device 30 recognizes that the item RO is mobile by the parts R6 which are wheels. That is, the information processing device 30 recognizes that the item RO can be operated by the parts R3, R5, and R6. Note that details of the method of recognizing the item RO will be described later. The information processing device 30 has a function of providing an image in which the item object R indicating the item RO that has been recognized and an object C indicating a character or the like interact with each other in the virtual space V. The object C is an example of a second object.

Referring back to FIG. 1, the display system 100 includes a sensor unit 10, a display device 20, and the information processing device 30. The information processing device 30 is capable of communicating with the sensor unit 10 and the display device 20.

The sensor unit 10 includes various sensors and the like that measure the reality environment. The sensor unit 10 includes, for example, an imaging device (sensor) such as a time of flight (ToF) camera, an RGB camera, a stereo camera, a monocular camera, an infrared camera, a depth camera, and other cameras. The sensor unit 10 includes, for example, a sensor such as an ultrasonic sensor, a radar, a light detection and ranging or laser imaging detection and ranging (LiDAR), or a sonar. The sensor unit 10 supplies measurement information measured by a sensor to the information processing device 30.

The display device 20 has a function of displaying various types of information. The display device 20 is controlled by the information processing device 30. The display device 20 includes, for example, a display device or the like that displays various types of information. Examples of the display device include a liquid crystal display (LCD) device, an organic light emitting diode (OLED) device, a touch panel, and the like. Furthermore, the display device 20 according to the present embodiment may output information or the like by a projection function.

[Configuration of Information Processing Device According to Embodiment]

The information processing device 30 is, for example, a dedicated or general-purpose computer. The information processing device 30 includes a storage unit 31 and a control unit 32. The information processing device 30 may be incorporated, for example, in the same housing as at least one of the sensor unit 10 and the display device 20. The control unit 32 of the information processing device 30 is electrically connected with the storage unit 31.

The storage unit 31 stores various types of data and programs. The storage unit 31 is implemented by, for example, a semiconductor memory element such as a RAM or a flash memory or a storage device such as a hard disk or an optical disk. The storage unit 31 stores a first piece of information 31A indicating the structure or the like of the item object R obtained by capturing a real item into the virtual space V. The item object R reproduces the item RO obtained by capturing the item RO from the reality environment into the virtual space V.

The storage unit 31 stores map information 31M obtained by measuring the reality environment. The map information 31M includes, for example, a higher order environment recognition map. The map information 31M includes, for example, the three-dimensional shape of the reality environment, color information, position information for every item, category information, identification information, and the like. The position information includes, for example, information indicating the position of an item in the virtual space. The category information includes, for example, information indicating a range of items having a similar property. For example, in a case of an indoor environment, category information includes information indicating a chair, a desk, a bed, a computer, tools, electrical appliances, and the like. The identification information includes, for example, information allows the item object R to be identified.

The storage unit 31 stores, for example, information such as an item recognition model 311, a structure and physical property model 312, a structural condition data base (DB) 313, a 3D model DB 314, and an object DB 315.

The item recognition model 311 has, for example, data indicating a model for recognizing the item RO that has been machine-learned. The structure and physical property model 312 has, for example, data indicating a model for recognizing the structure and physical properties of the item RO. The structural condition DB 313 has, for example, data indicating a structural condition for recognizing an item that has been machine-learned. The 3D model DB 314 has information indicating, for example, the shape, the structure, physical properties, the motion, and the like of the item that has been machine-learned. The 3D model DB 314 is configured using, for example, 3D modeling software or the like. The object DB 315 has, for example, data indicating the structure and physical properties of the object C.

The storage unit 31 further stores an arrangement condition 31C of the object C in the virtual space V. The arrangement condition 31C indicates, for example, a condition such as how the object C and the item object R are caused to interact with each other. The arrangement condition 31C includes arrangement conditions 31C of the object C such as “sit down on the chair”, “seated at the chair while leaning back”, “push and move the chair”, “stand up”, “lie down”, and “lean on”. For example, in a case where the condition is related to an operation, the arrangement condition 31C is associated with operation information 31D. The operation information 31D includes, for example, information indicating the operation of the object C with respect to the item object R. For example, in the case of the arrangement condition 31C indicating “seated at the chair while leaning back”, the operation information 31D includes information indicating that the object C operates (moves) the item object R while leaning back against the backrest of the chair.

Note that not all of the item recognition model 311, the structure and physical property model 312, the structural condition DB 313, the 3D model DB 314, the object DB 315, and an interaction DB 316 need to be stored in the storage unit 31 and may be stored in, for example, an information processing server, a storage device, or the like that is accessible by the information processing device 30.

The control unit 32 includes functional units such as a measurement unit 321, a first recognition unit 322, a second recognition unit 323, a missing part detecting unit 324, an estimation unit 325, and a display control unit 326. In the present embodiment, the control unit 32 further includes a functional unit which is a missing part complementing unit 324A. Each functional unit of the control unit 32 is implemented by, for example, a central processing unit (CPU), a micro control unit (MCU), or the like executing a program stored inside the information processing device 30 using a random access memory (RAM) or the like as a work area. Furthermore, each functional unit may be implemented by, for example, an integrated circuit such as an application specific integrated circuit (ASIC) or a field-programmable gate array (FPGA).

The measurement unit 321 measures a real item RO in the reality environment P on the basis of measurement information of the sensor unit 10. The measurement unit 321 measures a geometric shape in the reality environment using, for example, known three-dimensional measurement technology. As the three-dimensional measurement technology, for example, technology such as ToF or structure-from-motion can be used. The measurement unit 321 supplies measurement information indicating a geometric shape, a position, and the like in the reality environment P to the first recognition unit 322. The measurement unit 321 stores the measurement information in the storage unit 31 as the map information 31M of the reality environment.

The first recognition unit 322 recognizes the item RO in the reality environment on the basis of the measurement information from the measurement unit 321. For example, the item recognition model 311 includes a plurality of models such as a sofa, a chair, a window, a television, a table, a desk, a mat, a human, and an animal. In this case, the first recognition unit 322 searches for a model that matches or is similar to the geometric shape indicated by the measurement information from among the models of the item recognition model 311 and recognizes the item RO in the reality environment as the item object R on the basis of the model. The first recognition unit 322 supplies the recognition result to the second recognition unit 323.

The second recognition unit 323 recognizes the structure, physical properties, and the like of the item object R recognized by the first recognition unit 322. For example, the structure and physical property model 312 has a model that links the above-described model with the structure and physical properties. For example, the second recognition unit 323 searches for a model that matches or is similar to the item object R that has been recognized from among the models of the structure and physical property model 312 and recognizes the structure and physical properties indicated by the model as the structure and physical properties of the item. The second recognition unit 323 segments the item object R for each part using, for example, well-known technology. The second recognition unit 323 recognizes joint parts from the parts of the item object R. The second recognition unit 323 generates the first piece of information 31A indicating the recognition result and stores the first piece of information 31A that has been generated in the storage unit 31 in association with the item object R that has been recognized. Note that the second recognition unit 323 may include the first recognition unit 322 in its configuration or may be a separate recognition unit.

The missing part detecting unit 324 detects a structural missing part of the item object R that has been recognized. For example, in a case where the sensor unit 10 measures the reality environment P, there are cases where not the entire shape of an item can be measured due to the measured angle or the positional relationship between items. The missing part detecting unit 324 detects a missing part of an item on the basis of the structural condition of the item included in the structural condition DB 313. The structural condition of an item includes, for example, components of the item and a condition for recognizing a structure such as the positional relationship of the components. For example, in a case where the item is a chair, components of the item are required to have a structure including a seat and a plurality of legs. The missing part detecting unit 324 detects a missing part, safety, or the like of the item by performing physical simulation on the item RO that has been recognized. The physical simulation is, for example, a program for confirming the behavior or the stability of an item. The missing part detecting unit 324 supplies the detection result to the estimation unit 325.

In a case where the missing part detecting unit 324 detects a missing part, the missing part complementing unit 324A changes the first piece of information 31A so that the missing part is complemented. For example, the missing part complementing unit 324A recognizes a missing part of the item object R on the basis of data such as the shape, the structure, and physical properties of a 3D model (item) included in the 3D model DB 314 and complements the missing part. When the missing part complementing unit 324A complements the missing part, the missing part complementing unit 324A adds information corresponding to the complemented part to the first piece of information 31A.

The estimation unit 325 estimates an operable part of the item object R on the basis of the structure of a model similar to the item object R. For example, the estimation unit 325 estimates a part as a joint of the item object R and estimates an operable part of the item object R on the basis of the part. For example, in a case where an interaction is performed from the object C to the item object R, the estimation unit 325 estimates a part to be a fulcrum at the time of operation and estimates a part that is movable with the part as a fulcrum. For example, in a case where there is a part that moves by a part as a joint, the estimation unit 325 estimates the part as an operable part. For example, in a case where the item object R is a laptop computer, a display is included in the folded lid portion, and a keyboard is included in the main body portion. In this case, the estimation unit 325 estimates a part including the keyboard of the computer as an operable part. The estimation unit 325 reflects the estimation result in the first piece of information 31A.

The display control unit 326 generates a VR image based on the map information 31M and performs control to display the VR image on the display device 20. The VR image is an image obtained by three-dimensional reconstruction of the real world. The display control unit 326 has a function of displaying the object C based on the object DB 315 in the virtual space V. The display control unit 326 performs control to display a VR image indicating that the object C operates the item object R on the display device 20. As a result, the display device 20 displays a VR image in which the object C operates a part of the item object R obtained by capturing the reality environment P into the virtual space V.

The display control unit 326 controls the display device 20 to display the motion of a part of the item object R operated by the object C on the basis of the operation information 31D and the first piece of information 31A of the item object R. For example, the display control unit 326 specifies a part of the item object R that moves according to the operation information 31D on the basis of the operation information 31D and the first piece of information 31A and controls the display device 20 so that the part moves in conjunction with the object C. The display control unit 326 modifies the shape of a part of the item object R that moves in accordance with the operation information 31D on the basis of the operation information 31D and the first piece of information 31A and controls the display of the display device 20 so that the object C follows the part.

The display control unit 326 has a function of determining a motion of the part of the item object R to be operated by the object C on the basis of the operation information 31D and the first piece of information 31A. The display control unit 326 has a function of specifying a part of the item object R that moves in accordance with the operation information 31D on the basis of the operation information 31D and the first piece of information 31A and determining a motion of the part that is in conjunction with the object C.

The display control unit 326 modifies the shape of a part of the item object R that moves in accordance with the operation information 31D on the basis of the operation information 31D and the first piece of information 31A and controls the display of the display device 20 so that a part of the object C or the whole object C follows the part. In a case where a part of the item object R is modified of the shape and thereby displayed on the display device 20, the display control unit 326 restores a VR image of the background portion where the part has been displayed before the modification of the shape.

The functional configuration example of the information processing device 30 according to the present embodiment has been described above. Note that the configuration described above by referring to FIG. 1 is merely an example, and the functional configuration of the information processing device 30 according to the present embodiment is not limited to such an example. The functional configuration of the information processing device 30 according to the present embodiment can be flexibly modified depending on specifications or the use.

[Processing Procedure of Information Processing Device According to Embodiment]

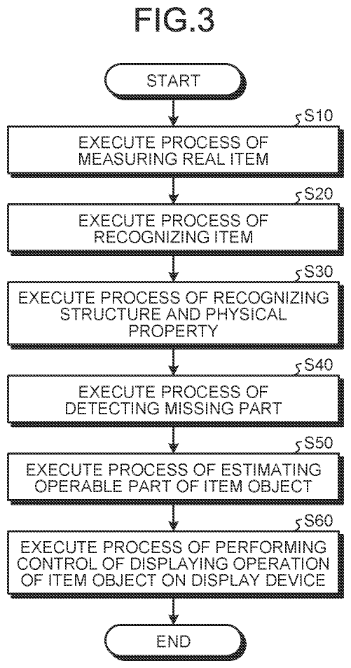

Next, an example of a processing procedure of the information processing device 30 according to the embodiment will be described. FIG. 3 is a flowchart illustrating an example of a processing procedure executed by the information processing device 30 according to the embodiment. The processing procedure illustrated in FIG. 3 is implemented by the control unit 32 of the information processing device 30 executing a program. The processing procedure illustrated in FIG. 3 is repeatedly executed by the control unit 32.

As illustrated in FIG. 3, the control unit 32 of the information processing device 30 executes a process of measuring a real item RO (step S10). For example, the control unit 32 measures the geometric shape in the reality environment P as a real item on the basis of the measurement information of the sensor unit 10 and stores measurement information indicating the measurement result in the storage unit 31. The control unit 32 functions as the measurement unit 321 described above by executing the process of step S10. When the process of step S10 is completed, the control unit 32 advances the process to step S20.

The control unit 32 executes a process of recognizing the item RO (step S20). For example, the control unit 32 recognizes the item RO in the reality environment P on the basis of the measurement information and the item recognition model 311. The control unit 32 recognizes the structure, the category, and the like for every item RO that has been recognized. For example, the control unit 32 searches for a model that matches or is similar to the geometric shape indicated by the measurement information from among the models of the item recognition model 311 and recognizes the model as the item object R. The control unit 32 recognizes the structure indicated by the model retrieved from the item recognition model 311 as the structure of the item object R. When the process of step S20 is completed, the control unit 32 advances the process to step S30. Note that the control unit 32 functions as the first recognition unit 322 described above by executing the process of step S20.

The control unit 32 executes a process of recognizing the structure and physical properties (step S30). For example, the control unit 32 searches for a model that matches or is similar to the item RO that has been recognized from among the models of the structure and physical property model 312 and recognizes the structure and physical properties indicated by the model as the structure and physical properties of the item.

For example, the structure and physical property model 312 stores physical property information in the storage unit 31 or the like in association with the model. The physical property information indicates, for example, a relationship between an element of a model 311M and a physical property. In this case, the control unit 32 extracts physical property information associated with the model from the structure and physical property model 312 and recognizes the physical property information as the physical property of an element of the item object R on the basis of the physical property information. For example, in a case where the item object R is a chair, the control unit 32 recognizes from the physical property information that has been extracted that the item object R has physical properties such as that the softness of the seat is high, that the softness of the backrest is moderate, and that the rigidity of the legs is high.

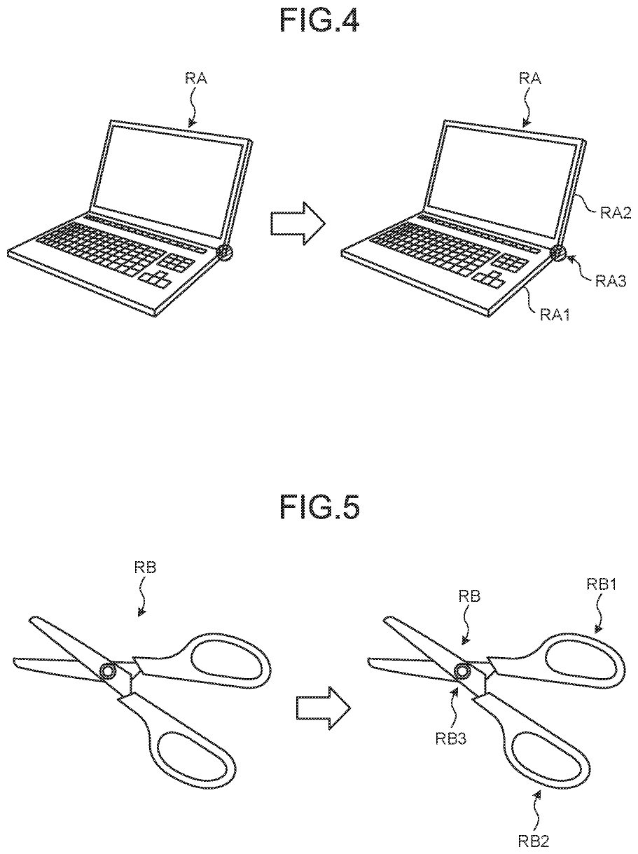

An example of recognizing the structure of an item RO of the control unit 32 will be described by referring to FIGS. 4 and 5. FIG. 4 is a diagram for explaining an example in which the information processing device 30 recognizes the structure of an item RO. FIG. 5 is a diagram for explaining an example in which the information processing device 30 recognizes the structure of another item RO.

In the example illustrated in FIG. 4, the control unit 32 has searched for a model that matches or is similar to the geometric shape indicated by the measurement information from among the models of the item recognition model 311 in step S20 and recognized that an item object RA is a laptop computer. In step S30, the control unit 32 has recognized parts RA1, RA2, and RA3, which are components of the item object RA. The part RA1 is a main body. The part RA2 is a lid. The part RA3 is a joint that opens and closes the main body and the lid. In this case, for example, the control unit 32 generates the first piece of information 31A indicating the structure, the shape, the position, and the like of the item object RA obtained by capturing a real item into the virtual space V and stores the first piece of information 31A in the storage unit 31. The first piece of information 31A is associated with the item object RA. The first piece of information 31A is associated with identification information, shape information, position information, and the like, for example, for each of the parts RA1, RA2, and RA3. The identification information includes, for example, information for identifying the item object RA. The shape information includes, for example, information such as vertex definition and mesh definition. The position information includes, for example, information indicating the position in the virtual space.

In the example illustrated in FIG. 5, the control unit 32 has searched for a model that matches or is similar to the geometric shape indicated by the measurement information from among the models of the item recognition model 311 in step S20 and recognized that an item object RB is a pair of scissors. In step S30, the control unit 32 has recognized parts RB1, RB2, and RB3, which are components of the item object RB. The part RB1 is a one member. The part RB2 is another member. The part RB3 is a contact point as a fulcrum of the part RB1 and the part RB2. In this case, for example, the control unit 32 generates the first piece of information 31A indicating the structure, the shape, the position, and the like of the item object RB obtained by capturing a real item into the virtual space V and stores the first piece of information 31A in the storage unit 31. The first piece of information 31A is associated with the item object RB. The first piece of information 31A is associated with identification information, shape information, position information, and the like, for example, for each of the parts RB1, RB2, and RB3. Note that, in the following description, the item objects RA and RB may be referred to as item objects R when they are not distinguished from each other.

Referring back to FIG. 3, when the process of step S30 is completed, the control unit 32 advances the process to step S40. Note that the control unit 32 functions as the second recognition unit 323 described above by executing the process of step S30.

The control unit 32 executes a process of detecting a missing part (step S40). For example, the control unit 32 detects a structural missing part of the item object R that has been recognized on the basis of the structural condition of the item included in the structural condition DB 313 that has been machine-learned. For example, the control unit 32 acquires a structural condition associated with a model that matches or is similar to the item object R that has been recognized from the structural condition DB 313. The control unit 32 compares the measurement information with the structural condition and determines that there is a missing part when it is detected that an essential part of the item object R is missing. When it is determined that there is a missing part, the control unit 32 executes a process of complementing the missing part. For example, the control unit 32 recognizes a missing part of the item object R on the basis of data such as the shape, the structure, and physical properties of the item RO included in the 3D model DB 314 and complements the missing part. When the missing part is complemented, the control unit 32 adds information corresponding to the complemented part to the first piece of information 31A. When the process of step S40 is completed, the control unit 32 advances the process to step S50. Note that the control unit 32 functions as the above-described missing part detecting unit 324 and the missing part complementing unit 324A by executing the process of step S40.

The control unit 32 executes a process of estimating an operable part of the item object R (step S50). For example, the control unit 32 estimates a part as a joint of the item object R on the basis of the structure and the function of a model similar to the item object R and estimates the presence or absence of movable parts by referring to the part as a joint. In a case where there is an operable part, the control unit 32 associates motion information 31B indicating that the part is operable with a corresponding part of the first piece of information 31A. The motion information 31B includes, for example, information indicating a motion mode, a motion of the part, a movable range, and the like. In a case where the item object R has a plurality of motion modes, the control unit 32 associates the motion information 31B with a part of a corresponding motion mode.

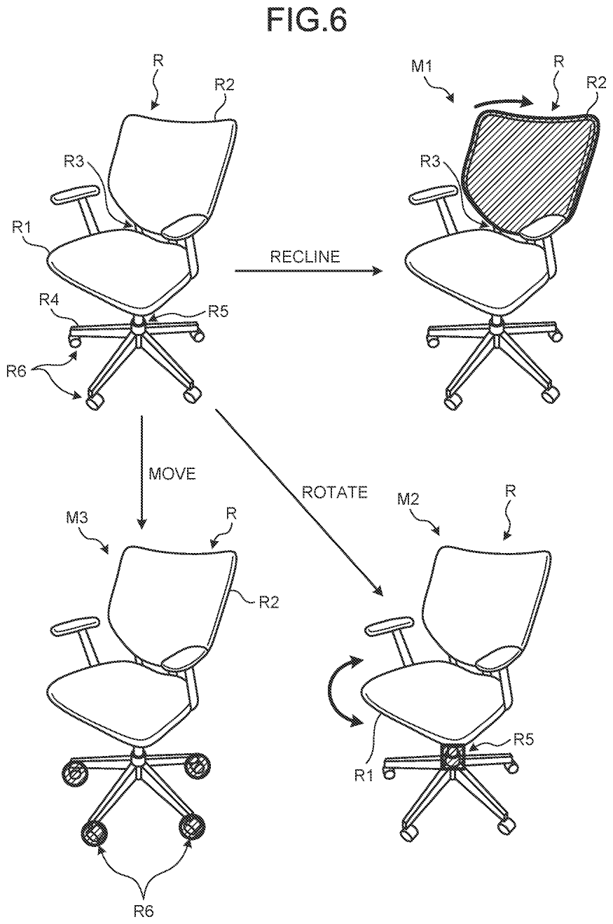

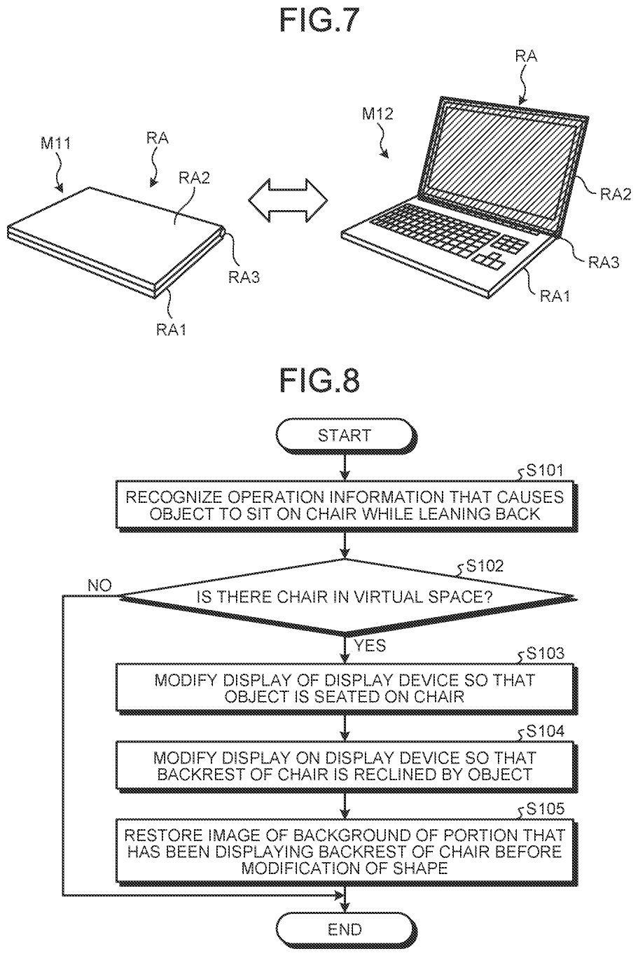

An example in which the control unit 32 of the information processing device 30 estimates an operable part of the item RO will be described by referring to FIGS. 6 and 7. FIG. 6 is a diagram for explaining an example in which the information processing device 30 estimates an operable part of an item object R. FIG. 7 is a diagram for explaining an example in which the information processing device 30 estimates an operable part of another item object R.

In the example illustrated in FIG. 6, the control unit 32 recognizes that the item object R is a chair by the processes of steps S20 and S30 and the like. The item object R has parts R1, R2, R3, R4, R5, and R6. The item object R has three motion modes M1, M2, and M3. The motion mode M1 is, for example, a mode of reclining the item object R. The motion mode M2 is, for example, a mode of rotating the item object R. The motion mode M3 is, for example, a mode of moving the item object R.

In a case where the item object R is in the motion mode M1, the control unit 32 estimates that it is possible to incline the part R2 of the backrest using the part R3 as a joint as the movable portion. In this case, since the part R2 of the item object R is operable, the control unit 32 associates the motion information 31B of the motion mode M1 with the first piece of information 31A. The motion information 31B of the motion mode M1 includes, for example, information indicating the operable part R2, the part R3 which is a movable portion, a movable range of the part R2, and the like.

In a case where the item object R is in the motion mode M2, the control unit 32 estimates that it is possible to rotate the portion above the part R1 of the seat using the part R5 as a joint as the rotation axis. In this case, since the part R1 of the item object R is operable, the control unit 32 associates the motion information 31B of the motion mode M2 with the first piece of information 31A. The motion information 31B of the motion mode M2 includes, for example, information indicating the operable parts R1 and R2, the part R5 serving as a rotation axis, and the like.

In a case where the item object R is in the motion mode M3, the control unit 32 estimates that it is possible to move the item object R using a plurality of parts R6. In this case, since it is possible to perform an operation of moving the item object R by the plurality of parts R6, the control unit 32 associates the motion information 31B of the motion mode M3 with the first piece of information 31A. The motion information 31B of the motion mode M3 includes, for example, information indicating an operable part R6, an operation method, and the like. The operation method includes, for example, an operation of pushing or pulling the part R2 of the backrest.

In the example illustrated in FIG. 7, the control unit 32 recognizes that the item object RA is a laptop computer by the processes of steps S20 and S30 and the like. The item object RA has parts RA1, RA2, and RA3. The item object RA has two motion modes M11 and M12. The motion mode M11 is, for example, a mode in which the item object RA is closed. The motion mode M12 is, for example, a mode in which the item object RA is opened.

In a case where the item object RA is in the motion mode M11, the control unit 32 estimates that it is possible to open the part RA2 of the lid using the part RA3 as a joint as the movable portion. In this case, since the part RA2 of the item object RA is operable, the control unit 32 associates the motion information 31B of the motion mode M11 with the first piece of information 31A. The motion information 31B of the motion mode M11 includes, for example, information indicating the operable part RA2, the part RA3 which is a movable portion for a motion, a movable range of the part RA2, and the like.

In a case where the item object RA is in the motion mode M12, the control unit 32 estimates that it is possible to close the part RA2 of the lid by referring to the part RA3 as a joint and to operate the keyboard of the part RA1 of the main body. In this case, since the parts RA1 and RA2 of the item object RA are operable, the control unit 32 associates the motion information 31B of the motion mode M12 with the first piece of information 31A. The motion information 31B of the motion mode M12 includes, for example, information indicating operable parts RA1 and RA2, a reference part RA3, a movable range of the part RA2, an operation method, and the like. The operation method includes, for example, a method of closing the lid, a method of operating the keyboard, and the like.

Referring back to FIG. 3, when the process of step S50 is completed, the control unit 32 advances the process to step S60. Note that the control unit 32 functions as the estimation unit 325 described above by executing the process of step S50.

The control unit 32 executes a process of performing control to display the operation of the item object R on the display device 20 (step S60). For example, the control unit 32 generates a VR image on the basis of the first piece of information 31A, the map information 31M, and the like and performs control to display the VR image on the display device 20. As a result, the display device 20 displays the virtual space V including the item object R obtained by capturing the reality environment into the virtual space V. Furthermore, the control unit 32 generates a VR image so as to display the object C in the virtual space V on the basis of the object DB 315 and performs control to display the VR image on the display device 20. As a result, the display device 20 displays the virtual space V including the item object R and the object C obtained by capturing the reality environment into the virtual space V. Then, the control unit 32 controls the display device 20 to display the motion of a part operated by the object C on the basis of the operation information 31D for the item object R and the first piece of information 31A.

An example in which the object C operates the item object R by the information processing device 30 will be described by referring to FIGS. 8 to 10.

FIG. 8 is a flowchart illustrating an example of a processing procedure regarding an operation of the object C of the information processing device 30 according to the embodiment. The processing procedure illustrated in FIG. 8 is implemented by the control unit 32 executing the process of step S60. The processing procedure illustrated in FIG. 8 is executed in a case where the control unit 32 causes the object C to sit on a chair while leaning back in a state where the virtual space V is displayed on the display device 20 by a VR image.

As illustrated in FIG. 8, the control unit 32 recognizes the operation information 31D for causing the object C to sit on a chair while leaning back (step S101). The control unit 32 determines whether or not there is a chair in the virtual space V (step S102). For example, the control unit 32 searches the virtual space V for a chair that meets the condition of the operation information 31D. In a case where a chair having a backrest is detected in the virtual space V, the control unit 32 determines that there is a chair in the virtual space V. If it is determined that there is no chair in the virtual space V (No in step S102), the control unit 32 terminates the processing procedure illustrated in FIG. 8 and returns to the process of step S60 illustrated in FIG. 3. Alternatively, if it is determined that there is a chair in the virtual space V (Yes in step S102), the control unit 32 advances the process to step S103.

The control unit 32 modifies the display of the display device 20 so that the object C is seated on the chair (step S103). For example, the control unit 32 modifies the display of the display device 20 so that the object C appears in the virtual space V, moves on foot toward the position of the chair in the virtual space V, and sits on the seat of the chair. Note that the control unit 32 recognizes a region of the virtual space V where the object C can walk and a route for avoiding obstacles such as items from the map information 31M. When the object C is seated on the chair, the control unit 32 advances the process to step S104.

The control unit 32 modifies the display of the display device 20 so that the backrest of the chair is reclined by the object C (step S104). For example, the control unit 32 modifies the display of the display device 20 so that the backrest reclines depending on the operation on the backrest on which the object C leans using the part as a joint of the chair as a movable portion (rotation axis). Specifically, the control unit 32 modifies the VR image on the basis of the map information 31M so that the backrest of the chair in the virtual space V is gradually modified of the shape and displays this VR image on the display device 20. As a result, the display device 20 can display the VR image in which the backrest of the chair reclines in conjunction with the leaning motion of the object C.

The control unit 32 restores the background image of the portion where the backrest of the chair has been displayed before the modification of the shape (step S105). For example, in a case where the backrest of the chair is modified of the shape, the data before the modification of the VR image is the three-dimensional shape of the chair currently or previously measured and color information corresponding thereto. Therefore, the control unit 32 repairs the image of the background of the portion where the backrest part has been displayed before the modification of the shape on the basis of the color information and the like. As a result, even when the backrest of the chair is modified of the shape, the information processing device 30 can display, on the display device 20, an image of the background or the like at the portion before the modification of the shape, and thus the VR image can be visually recognized without discomfort. In addition, with the item RO having a large size such as a chair, there is a possibility that an unmeasured portion of the background appears as the foreground is modified of the shape. In this case, the control unit 32 may execute an inpainting process of the background using three-dimensional shapes and color information of the walls, the floor, and the like in the virtual space V.

When the process of step S105 is completed, the control unit 32 ends the processing procedure illustrated in FIG. 8 and returns to the process of step S60 illustrated in FIG. 3.

In the processing procedure illustrated in FIG. 8, step S104 and step S105 have been described as separate processes, however, the present invention is not limited thereto. In the processing procedure illustrated in FIG. 8, the process of step S105 may be included in the process of step S104, or it may be modified so that the processes are performed simultaneously.

In the present embodiment, a scene has been described in which the information processing device 30 uses the processing procedure described in FIG. 8 to cause the object C to recline on a chair, however, a substantially similar processing procedure can be used also in a case where the object C rotates while seated on the chair. For example, in the processing procedure illustrated in FIG. 8, it is only required to change the process of step S104 to a process of modifying the display of the display device 20 so that a part above the seat of the chair is rotated by the object. In addition, in a case where the chair is pushed and moved, it is not necessary to modify the shape of the parts of the chair, and thus it is only required to use a processing procedure of moving the entire chair depending on the operation of the object C.

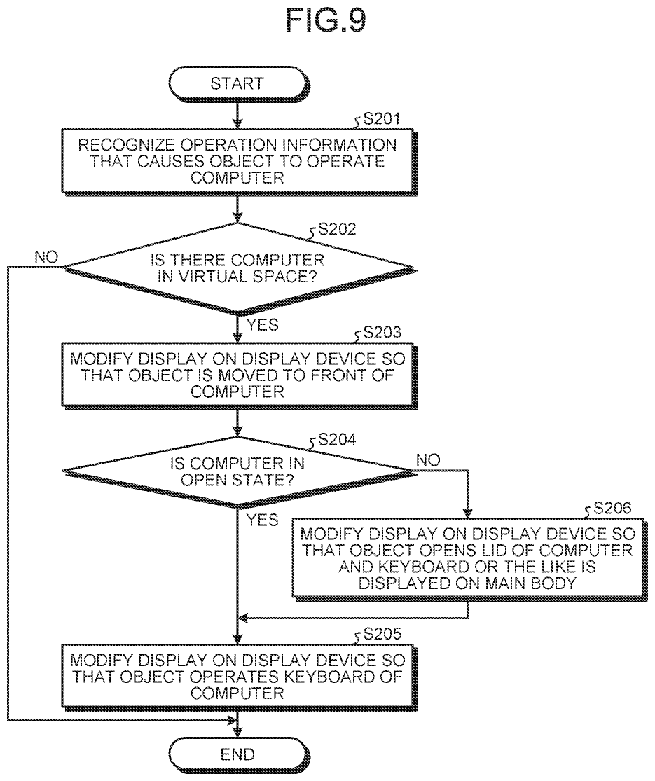

FIG. 9 is a flowchart illustrating another example of a processing procedure regarding an operation of the object C of the information processing device 30 according to the embodiment. The processing procedure illustrated in FIG. 9 is implemented by the control unit 32 executing the process of step S60. The processing procedure illustrated in FIG. 9 is executed in a case where the control unit 32 causes the object C to operate a laptop computer in a state where the control unit 32 is causing the display device 20 to display the virtual space V by a VR image.

As illustrated in FIG. 9, the control unit 32 recognizes the operation information 31D for causing the object C to operate the computer (step S201). The control unit 32 determines whether or not there is a computer in the virtual space V (step S202). For example, the control unit 32 searches the virtual space V for a computer that meets the condition of the operation information 31D. In a case where a laptop computer is detected in the virtual space V, the control unit 32 determines that there is a computer in the virtual space V. If it is determined that there is no computer in the virtual space V (No in step S202), the control unit 32 terminates the processing procedure illustrated in FIG. 9 and returns to the process of step S60 illustrated in FIG. 3. Alternatively, if it is determined that there is a computer in the virtual space V (Yes in step S202), the control unit 32 advances the process to step S203.

The control unit 32 modifies the display of the display device 20 so that the object C moves to the front of the computer (step S203). For example, the control unit 32 modifies the display of the display device 20 so that the object C appears in the virtual space V, moves on foot toward the position of the computer in the virtual space V, and moves to a position where the object C can operate the computer. Note that the control unit 32 recognizes a region of the virtual space V where the object C can walk and a route for avoiding obstacles such as other items from the map information 31M. When the object C is caused to move to the front of the computer, the control unit 32 advances the process to step S204.

The control unit 32 determines whether or not the computer is in an open state (step S204). For example, as described above, in a case where the item object RA is in the motion mode M12, the control unit 32 determines that the computer is in the open state. If it is determined that the computer is in an open state (Yes in step S204), the control unit 32 advances the process to step S205.

The control unit 32 modifies the display of the display device so that the object C operates the keyboard of the computer (step S205). For example, the control unit 32 modifies the display of the display device 20 so that the object C operates the region of the keyboard of the part RA1 of the computer (item object RA). Specifically, the control unit 32 modifies the VR image so that a hand of the object C operates the region of the keyboard of the part RA1 of the computer on the basis of the map information 31M and displays the VR image on the display device 20. The control unit 32 restores a background image of a portion where the lid of the computer has been displayed before the modification of the shape. As a result, the display device 20 can display a VR image in which the object C operates the keyboard of the computer. Note that the control unit 32 may modify the display of the display device so as to display characters, images, and the like on the display of the computer depending on the operation of the keyboard. Then, when the process of step S205 is completed, the control unit 32 ends the processing procedure illustrated in FIG. 9 and returns to the process of step S60 illustrated in FIG. 3.

If it is determined that the computer is not in an open state (No in step S204), the control unit 32 advances the process to step S206 since the computer is in a closed state. The control unit 32 modifies the display of the display device 20 so that the object C opens the lid of the computer and displays the keyboard or the like on the main body (step S206). For example, the control unit 32 modifies the display of the display device 20 so that the object C opens the lid of the computer depending on the operation of the object C using the part RA3 of as a joint of the computer (item object RA) as a movable portion (rotation axis). Specifically, the control unit 32 gradually opens the lid of the computer in the virtual space V on the basis of the map information 31M and modifies the display of the display device 20 so that the keyboard appears in the exposed portion of the main body. As a result, the display device 20 can display the VR image in which the computer shifts to an open state in conjunction with the opening operation of the object C. Then, when the process of step S206 is completed, the control unit 32 advances the process to step S205 that has been described earlier.

The control unit 32 modifies the display of the display device so that the object C operates the keyboard of the computer (step S205). As a result, the display device 20 can display a VR image in which the object C operates the keyboard of the computer that is open. Then, when the process of step S205 is completed, the control unit 32 ends the processing procedure illustrated in FIG. 9 and returns to the process of step S60 illustrated in FIG. 3.

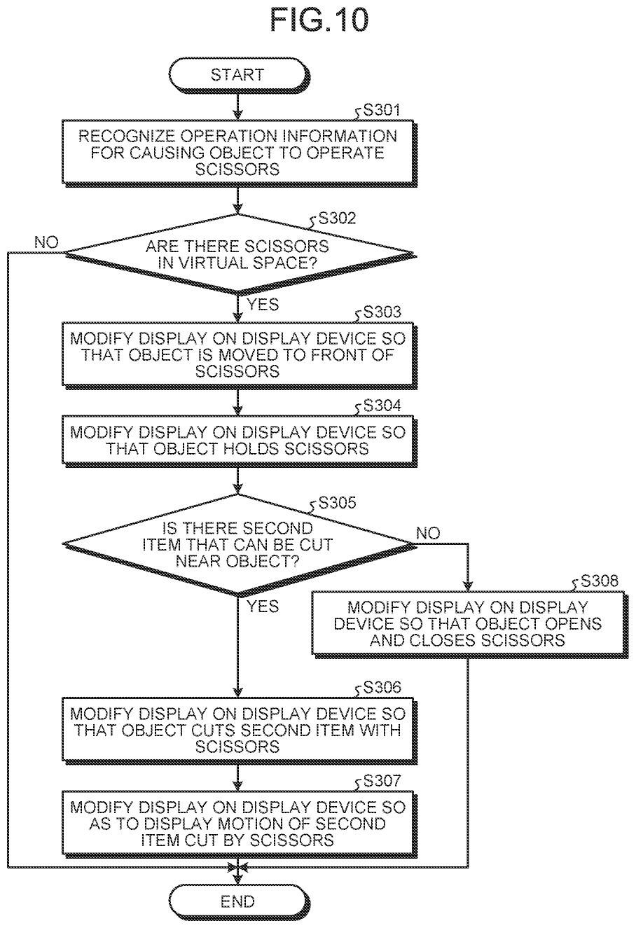

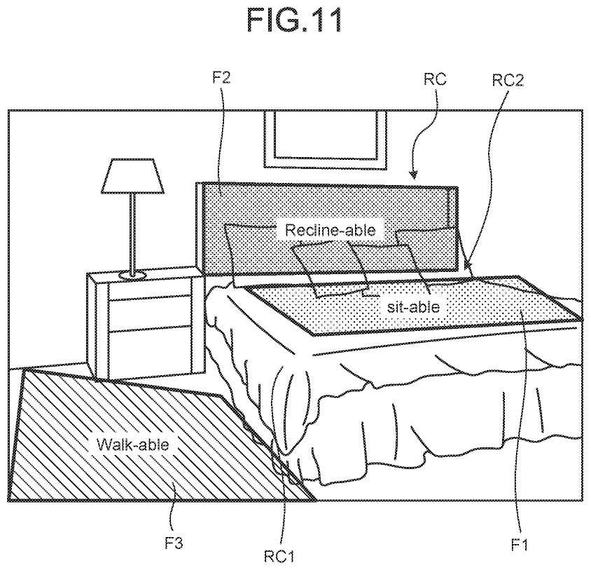

FIG. 10 is a flowchart illustrating another example of a processing procedure related to an operation of the object C of the information processing device 30 according to the embodiment. The processing procedure illustrated in FIG. 10 is implemented by the control unit 32 executing the process of step S60. The processing procedure illustrated in FIG. 10 is executed in a case where the control unit 32 causes the object C to operate scissors in a state where the control unit 32 is causing the display device 20 to display the virtual space V by a VR image.

As illustrated in FIG. 10, the control unit 32 recognizes the operation information 31D for causing the object C to operate the scissors (step S301). The control unit 32 determines whether or not there are scissors in the virtual space V (step S302). For example, the control unit 32 searches the virtual space V for scissors that meet the condition of the operation information 31D. In a case where scissors (item objects RB) are detected in the virtual space V, the control unit 32 determines that there are scissors in the virtual space V. If it is determined that there are no scissors in the virtual space V (No in step S302), the control unit 32 terminates the processing procedure illustrated in FIG. 10 and returns to the process of step S60 illustrated in FIG. 3. Alternatively, if it is determined that there are scissors in the virtual space V (Yes in step S302), the control unit 32 advances the process to step S303.

The control unit 32 modifies the display of the display device 20 so that the object C moves to the front of the scissors (step S303). For example, the control unit 32 modifies the display of the display device 20 so that the object C appears in the virtual space V, moves on foot toward the position of the scissors in the virtual space V, and moves to a position where the object C can operate the scissors. Note that the control unit 32 recognizes a region of the virtual space V where the object C can walk and a route for avoiding obstacles such as items from the map information 31M. When the object C is caused to move to the front of the scissors, the control unit 32 advances the process to step S304.

The control unit 32 modifies the display of the display device 20 so that the object C holds the scissors (step S304). For example, the control unit 32 modifies the display of the display device 20 so that the object C holds the scissors with fingers of the object C passing through the finger rings of the parts RB1 and RB2 of the scissors (item object RB). When the object C holds the scissors, the control unit 32 advances the process to step S305.

The control unit 32 determines whether or not there is a second item that is cuttable near the object C (step S305). For example, the control unit 32 searches the virtual space V for a second item that can be cut with the scissors on the basis of the category, physical properties, and the like of the item object R. The second item includes, for example, paper, cloth, and the like. In a case where an item object R that is cuttable is detected near the object C, the control unit 32 determines that there is a second item. If it is determined that there is a second item that is cuttable near the object C (Yes in step S305), the control unit 32 advances the process to step S306.

The control unit 32 modifies the display of the display device 20 so that the object C cuts the second item with the scissors (step S306). For example, the control unit 32 modifies the display of the display device 20 so that the object C holds the second item and cuts the second item by operating the scissors. When the object C cuts the second item with the scissors, the control unit 32 advances the process to step S307.

The control unit 32 modifies the display of the display device 20 so as to display the motion of the second item cut by the scissors (step S307). For example, the control unit 32 modifies the display of the display device 20 so as to display the motion of the second item modified of the shape into a shape corresponding to the cutting by the scissors. After displaying the motion of the second item, the control unit 32 terminates the processing procedure illustrated in FIG. 10 and returns to the process of step S60 illustrated in FIG. 3.

Alternatively, if it is determined that there is no second item that is cuttable near the object C (No in step S305), the control unit 32 advances the process to step S308. The control unit 32 modifies the display of the display device 20 so that the object C opens and closes the scissors in the virtual space V (step S308). For example, the control unit 32 modifies the display of the display device 20 so that the parts RB1 and RB2 of the scissors open and close depending on the operation of the object C. After displaying the motion of opening and closing the scissors, the control unit 32 terminates the processing procedure illustrated in FIG. 10 and returns to the process of step S60 illustrated in FIG. 3.

Referring back to FIG. 3, when the process of step S60 is completed, the control unit 32 terminates the processing procedure illustrated in FIG. 3. Note that the control unit 32 functions as the display control unit 326 described above by executing the process of step S60.

As described above, after the information processing device 30 according to the embodiment has captured the real item RO into the virtual space V as the item object R, the information processing device 30 estimates a part of the item object R that can be operated. The information processing device 30 controls the display device 20 so as to display the motion of a part operated by the object C on the basis of the operation information 31D of the object C with respect to the item object R and the first piece of information 31A. As a result, the information processing device 30 can cause the object C to operate the part by estimating an operable part of the item object R in the virtual space V obtained by capturing the reality environment P. As a result, it is possible to operate the item object R obtained by capturing the real item RO in the virtual reality, and thus the information processing device 30 can improve the reality of the item object R in the virtual reality.

Note that the above-described embodiment is an example, and various modifications and applications are possible.

### First Modification of Embodiment

FIG. 11 is a diagram illustrating an estimation example of an operable part of an item object R of an information processing device 30 according to a first modification of the embodiment. In the example illustrated in FIG. 11, the information processing device 30 recognizes that the item object RC is a bed. The item object RC includes parts RC1 and RC2. The part RC1 is a main body (mattress). The part RC2 is an upper part of the main body. In the first piece of information 31A of the item object RC, identification information, shape information, position information, and the like are associated for each of the parts RC1 and RC2. The information processing device 30 searches for a model that matches or is similar to an item RO that has been recognized from among the models of the structure and physical property model 312 and recognizes the structure and physical properties indicated by the model as the structure and physical properties of the item object RC.

The information processing device 30 has a function of estimating an operation area in the virtual space V related to the item object RC on the basis of a machine learning result or the like related to the model of the structure and physical property model 312. For example, the information processing device 30 estimates that the part RC1 has a function F1 of sit-able. For example, the information processing device 30 estimates that the part RC2 has a function F2 of recline-able. Furthermore, for example, the information processing device 30 estimates that a region adjacent to the part RC1 has a function F3 of walk-able. As a result, the information processing device 30 can apply the estimation result to the operation of the object C by estimating the functions related to the parts of the item object R.

For example, in a case of operation information 31D for reclining the bed, the information processing device 30 controls the display of the display device 20 so that the object C moves in the region of the function F3 in the virtual space V toward the item object RC. The information processing device 30 controls display of the display device 20 so that the object C reclines the item object RC. As a result, the information processing device 30 can express the operation of the item object RC obtained by capturing the real item RO in the virtual reality without a sense of discomfort, and thus the reality of the virtual reality can be improved.

### Second Modification of Embodiment

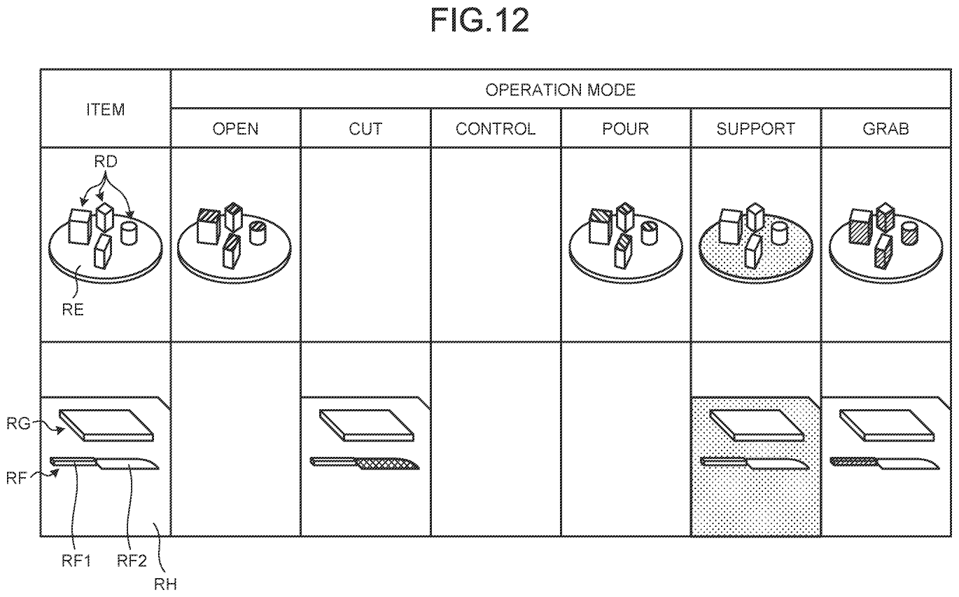

FIG. 12 is a table illustrating examples of operation modes of item objects R of the information processing device 30 according to a second modification of the embodiment. In the example illustrated in FIG. 12, the information processing device 30 recognizes item objects RD and an item object RE on which the item objects RD are placed. The item objects RD are, for example, containers. The item object RE is, for example, a table. Furthermore, the information processing device 30 recognizes an item object RF, an item object RG, and an item object RH on which the item object RF and the item object RG are placed. The item object RF is, for example, a kitchen knife. The item object RG is, for example, a cutting board. The item object RH is, for example, a table. The information processing device 30 recognizes parts RF1 and RF2 which are components of the item object RF. The part RF1 is a handle portion of the kitchen knife. The part RF2 is a blade portion of a kitchen knife.

The information processing device 30 has a function of estimating the operation mode of the plurality of item objects R. For example, the information processing device 30 searches for a model that matches or is similar to each of one of the item objects R that have been recognized and other item objects R from among models of the structure and physical property model 312 and recognizes the structure and physical properties indicated by the models as the structure and physical properties of the item objects R to be operated. For example, in a case where an operation target is an item object RD, the information processing device 30 associates information indicating the operation mode with the first piece of information 31A of the item object RD. In a case where an operation target is an item object RF, the information processing device 30 associates information indicating the operation mode with the first piece of information 31A of the item object RF. In the present embodiment, a case where the operation mode includes, for example, modes of opening, cutting, controlling, pouring, supporting, and grabbing will be described.

In the example illustrated in FIG. 12, the information processing device 30 estimates that the operation modes of opening, pouring, supporting, and grabbing can be operated and associates operation mode information indicating the estimation result with the first piece of information 31A of the item object RD. The operation mode information includes, for example, information indicating concerned parts of the item object RD and the item object RE for each operation mode. The operation mode information may indicate that the operation modes of cutting and controlling are not operable. Similarly, the information processing device 30 associates operation mode information indicating that operation modes of cutting, supporting, and grabbing are possible with the first piece of information 31A of the item object RF. The operation mode information includes, for example, information indicating concerned parts of the item objects RF, RG, and RH for each operation mode. For example, in a case where the operation mode of the item object RF is cutting, the information processing device 30 can estimate that the portion of the part RF2 cuts the second item. As a result, the information processing device 30 can accurately estimate parts related to the operation of the item objects RD and RF on the basis of the operation mode information, and thus the information processing device 30 can express the motion of the item object R by the operation of the object C without a sense of discomfort.

Note that the first modification and the second modification of the above-described embodiment are examples, and the first modification and the second modification may be combined.

[Hardware Configuration]

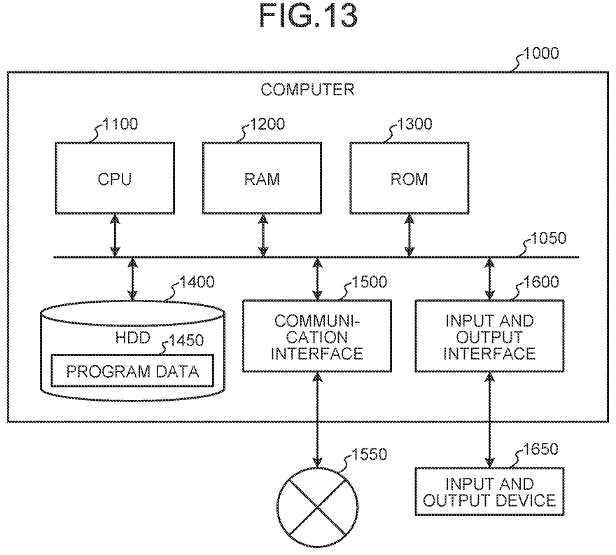

The information processing device 30 according to the present embodiment described above may be implemented by a computer 1000 having a configuration as illustrated in FIG. 13, for example. Hereinafter, the information processing device 30 according to the embodiment will be described as an example. FIG. 13 is a hardware configuration diagram illustrating an example of the computer 1000 that implements the functions of the information processing device 30. The computer 1000 includes a CPU 1100, a RAM 1200, a read only memory (ROM) 1300, a hard disk drive (HDD) 1400, a communication interface 1500, and an input and output interface 1600. The units of the computer 1000 are connected by a bus 1050.

The CPU 1100 operates in accordance with a program stored in the ROM 1300 or the HDD 1400 and controls each of the units. For example, the CPU 1100 develops a program stored in the ROM 1300 or the HDD 1400 in the RAM 1200 and executes processes corresponding to various programs.

The ROM 1300 stores a boot program such as a basic input output system (BIOS) executed by the CPU 1100 when the computer 1000 is activated, a program dependent on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure, which is an example of program data 1450.

The communication interface 1500 is an interface for the computer 1000 to be connected with an external network 1550 (for example, the Internet). For example, the CPU 1100 receives data from another device or transmits data generated by the CPU 1100 to another device via the communication interface 1500.

The input and output interface 1600 is an interface for connecting an input and output device 1650 and the computer 1000. For example, the CPU 1100 receives data from an input device such as a keyboard or a mouse via the input and output interface 1600. In addition, the CPU 1100 transmits data to an output device such as a display, a speaker, or a printer via the input and output interface 1600. Furthermore, the input and output interface 1600 may function as a media interface that reads a program or the like recorded in a predetermined recording medium (medium). A medium is, for example, an optical recording medium such as a digital versatile disc (DVD), a magneto-optical recording medium such as a magneto-optical disk (MO), a tape medium, a magnetic recording medium, a semiconductor memory, or the like.

For example, in a case where the computer 1000 functions as the information processing device 30 according to the embodiment, the CPU 1100 of the computer 1000 implements the functions of the measurement unit 321, the first recognition unit 322, the second recognition unit 323, the missing part detecting unit 324, the estimation unit 325, the display control unit 326, and the like of the control unit 32 by executing programs loaded on the RAM 1200. The HDD 1400 also stores a program according to the present disclosure or data in the storage unit 31. Note that although the CPU 1100 reads the program data 1450 from the HDD 1400 and executes the program data 1450, as another example, the CPU 1100 may acquire these programs from another device via the external network 1550.

Although the preferred embodiments of the present disclosure have been described in detail by referring to the accompanying drawings, the technical scope of the present disclosure is not limited to such examples. It is obvious that a person having ordinary knowledge in the technical field of the present disclosure can conceive various modifications or variations within the scope of the technical idea described in the claims, and it is naturally understood that these also belong to the technical scope of the present disclosure.

Furthermore, the effects described in the present specification are merely illustrative or exemplary and are not restrictive. That is, the technology according to the present disclosure can achieve other effects that are obvious to those skilled in the art from the description of the present specification together with or instead of the above effects.

Furthermore, it is also possible to create a program for causing hardware such as a CPU, a ROM, and a RAM built in a computer to implement functions equivalent to the configuration of the information processing device 30 and to provide a computer-readable recording medium recording the program.

Meanwhile, the steps according to the processes of the information processing device 30 in the present specification are not necessarily processed in time series in the order described in the flowchart. For example, the steps according to the processes of the information processing device 30 may be processed in an order different from the order described in the flowchart or may be processed in parallel.

(Effects)

The information processing device 30 includes: the estimation unit 325 that estimates an operable part among a plurality of parts of a first object obtained by capturing a real item RO into a virtual space V; and the display control unit 326 that controls the display device 20 to display a motion of the part of the first object operated by a second object indicating a virtual item on the basis of operation information 31D of the second object with respect to the first object and a first piece of information 31A indicating a result of the estimation unit 325.

As a result, the information processing device 30 can cause the second object to operate the part by estimating an operable part of the first object in the virtual space V capturing the reality environment. As a result, the second object can operate the first object obtained by capturing the real item RO in the virtual reality, and thus the information processing device 30 can improve the reality of the first object in the virtual reality.

In the information processing device 30, the display control unit 326 specifies a part of the first object that moves in accordance with the operation information 31D on the basis of the operation information 31D and the first piece of information 31A and controls the display of the display device 20 so that the part moves in conjunction with the second object.

As a result, the information processing device 30 can implement display in which an operable part moves by causing the operable part of the first object that has been specified to move in conjunction with the second object as the part is operated. As a result, the information processing device 30 can further improve the reality of the first object in the virtual reality by causing the operable part of the first object obtained by capturing in the virtual reality to move in conjunction with the second object.

In the information processing device 30, the display control unit 326 modifies the shape of a part of the first object that moves in accordance with the operation information 31D on the basis of the operation information 31D and the first piece of information 31A and controls the display of the display device 20 so that the second object follows the part.

As a result, the information processing device 30 can implement display in which a part of the first object is modified of the shape in accordance with the operation information 31D and the second object is caused to follow the part. As a result, the information processing device 30 can suppress generation of a sense of discomfort in the operation of the second object with respect to the first object in the virtual reality, and thus the information processing device 30 can further improve the reality of the first object.

In the information processing device 30, the estimation unit 325 estimates a movable part of the first object on the basis of the parts of the first object and the structure of the model that has been machine-learned, and the first piece of information 31A includes information that enables identification of an operable part estimated by the estimation unit 325.

As a result, the information processing device 30 can estimate the movable part of the first object and include, in the first piece of information 31A, information that enables identification of an operable part that has been estimated. As a result, the information processing device 30 can recognize the movable part of the first object on the basis of the first piece of information 31A, and thus it is possible to accurately grasp the part of the first object to be moved by the operation and to improve the reality regarding the operation.

In the information processing device 30, the estimation unit 325 estimates a part as a joint of the first object and estimates the operable part of the first object on the basis of the part.

As a result, the information processing device 30 can estimate the part as a joint of the first object and estimate the part of the first object that is operable on the basis of the part as a joint. As a result, the information processing device 30 can estimate an operable part by referring to the joint, and thus it is possible to prevent parts that cannot be operated from moving.

In the information processing device 30, the first piece of information 31A is associated with the motion information 31B indicating a motion mode of the first object, and the display control unit 326 specifies a part of the first object to be operated by the second object on the basis of the operation information 31D, the first piece of information 31A, and the motion information 31B.

As a result, the motion information 31B is associated with the first piece of information 31A, and the information processing device 30 can specify a part of the second object to be operated by the second object on the basis of the motion information 31B. As a result, it is possible to move a part of the first object corresponding to the motion mode of the first object, and thus the information processing device 30 can further improve the reality of the first object in the virtual reality.

In the information processing device 30, the first piece of information 31A includes information indicating an operable part of the first object in a plurality of the motion modes of the first object, and the display control unit 326 modifies the part operated by the second object when the motion mode of the first object changes.

As a result, in a case where the first object has a plurality of motion modes, the information processing device 30 can cause the second object to operate a part of the first object depending on a motion mode. As a result, it is possible to move a part of the first object that is suitable for each of the plurality of motion modes of the first object, and thus the information processing device 30 can further improve the reality of the first object in the virtual reality.

In the information processing device 30, in a case where a part of the first object is modified of the shape and thereby displayed on the display device 20, the display control unit 326 restores a background image of a portion where the part has been displayed before the modification of the shape.

As a result, in a case where the part of the first object is modified of the shape and thereby displayed on the display device 20, the information processing device 30 can restore a background image of the portion where the part has been displayed before the modification of the shape. As a result, the information processing device 30 can suppress a decrease in visibility in the display device 20 even when the part of the first object is moved.

In the information processing device 30, the estimation unit 325 estimates an operation area in the virtual space related to an operation of the first object, and the first piece of information 31A includes information related to the operation area estimated by the estimation unit 325.

As a result, the information processing device 30 can estimate the operation area regarding the operation of the first object and include information regarding the operation area in the first piece of information 31A. As a result, the second object can be disposed in the operation area on the basis of the first piece of information 31A, the information processing device 30 can improve the reality of the second object that operates the first object.

In the information processing device 30, the estimation unit 325 estimates an operation mode of the first object on the basis of the parts of the first object and the structure of the model that has been machine-learned, and the first piece of information 31A associates the operation mode estimated by the estimation unit 325 with the parts.

As a result, the information processing device 30 can estimate the operation mode for the first object and associate the operation mode with the parts of the first object. As a result, the part of the first object that corresponds to the operation mode can be grasped on the basis of the first piece of information 31A, and thus the information processing device 30 can further improve the reality of the first object.

An information processing method includes, by a computer, estimating an operable part among a plurality of parts of a first object obtained by capturing a real item into a virtual space and controlling a display device so as to display a motion of the part of the first object operated by a second object indicating a virtual item on the basis of operation information 31D of the second object with respect to the first object and a first piece of information 31A indicating a result of the estimation.

As a result, the information processing method can cause the second object to operate the part by causing the computer to estimate an operable part of the first object in the virtual space V capturing the reality environment. As a result, the second object can operate the first object obtained by capturing the real item RO in the virtual reality, and thus the information processing method can improve the reality of the first object in the virtual reality.

A program causes a computer to execute estimation of an operable part among a plurality of parts of a first object obtained by capturing a real item into a virtual space and control of a display device so as to display a motion of the part of the first object operated by a second object indicating a virtual item on the basis of operation information 31D of the second object with respect to the first object and a first piece of information 31A indicating a result of the estimation.

As a result, the program can cause the second object to operate the part by causing the computer to estimate an operable part of the first object in the virtual space V capturing the reality environment. As a result, the program can cause the second object to operate the first object obtained by capturing the real item RO in the virtual reality, and thus the program can improve the reality of the first object in the virtual reality.

Note that the following configurations also belong to the technical scope of the present disclosure.

(1)

An information processing device comprising:

an estimation unit that estimates an operable part among a plurality of parts of a first object obtained by capturing a real item into a virtual space; and

a display control unit that controls a display device so as to display a motion of the part operated by a second object indicating a virtual item on a basis of operation information of the second object with respect to the first object and a first piece of information indicating a result of the estimation unit.

(2)

The information processing device according to (1),

wherein the display control unit specifies the part of the first object that moves in accordance with the operation information on a basis of the operation information and the first piece of information and controls display of the display device so that the part moves in conjunction with the second object.

(3)

The information processing device according to (1) or (2),

wherein the display control unit modifies the part of the first object that moves in accordance with the operation information on a basis of the operation information and the first piece of information and controls display of the display device so that the second object follows the part.

(4)

The information processing device according to any one of (1) to (3),

wherein the estimation unit estimates the part of the first object that is movable on a basis of the parts of the first object and a structure of a model that has been machine-learned, and

the first piece of information includes information that enables identification of the operable part estimated by the estimation unit.

(5)

The information processing device according to (4),

wherein the estimation unit estimates the part of the first object as a joint and estimates the operable part of the first object on a basis of the part.

(6)

The information processing device according to any one of (1) to (5),

wherein the first piece of information is associated with motion information indicating a motion mode of the first object, and

the display control unit specifies the part of the first object operated by the second object on a basis of the operation information, the first piece of information, and the motion information.

(7)

The information processing device according to (6),

wherein the first piece of information includes information indicating the operable part of the first object in a plurality of the motion modes of the first object, and

the display control unit modifies the part operated by the second object when the motion mode of the first object changes.

(8)

The information processing device according to any one of (1) to (7),

wherein, in a case where the part of the first object is modified of a shape and displayed on the display device, the display control unit restores a background image of a portion where the part has been displayed before the modification of the shape.

(9)

The information processing device according to any one of (1) to (8),

wherein the estimation unit estimates an operation area in the virtual space related to an operation of the first object, and

the first piece of information includes information related to the operation area estimated by the estimation unit.

(10)

The information processing device according to any one of (1) to (9),

wherein the estimation unit estimates an operation mode of the first object on a basis of the parts of the first object and a structure of a model that has been machine-learned, and

the first piece of information associates the operation mode estimated by the estimation unit with the parts.

(11)

An information processing method by a computer, the method comprising the steps of:

estimating an operable part among a plurality of parts of a first object obtained by capturing a real item into a virtual space; and

controlling a display device so as to display a motion of the part operated by a second object indicating a virtual item on a basis of operation information of the second object with respect to the first object and a first piece of information indicating a result of the estimation.

(12)

A program for causing a computer to execute the steps of:

estimating an operable part among a plurality of parts of a first object obtained by capturing a real item into a virtual space; and

controlling a display device so as to display a motion of the part operated by a second object indicating a virtual item on a basis of operation information of the second object with respect to the first object and a first piece of information indicating a result of the estimation.

### REFERENCE SIGNS LIST

10 SENSOR UNIT
20 DISPLAY DEVICE
30 INFORMATION PROCESSING DEVICE
31A FIRST PIECE OF INFORMATION
31B MOTION INFORMATION
31C ARRANGEMENT CONDITION
31D OPERATION INFORMATION
31M MAP INFORMATION
32 CONTROL UNIT
321 MEASUREMENT UNIT
322 FIRST RECOGNITION UNIT
323 SECOND RECOGNITION UNIT
324 MISSING PART DETECTING UNIT
324A MISSING PART COMPLEMENTING UNIT
325 ESTIMATION UNIT
326 DISPLAY CONTROL UNIT
C OBJECT
P REALITY ENVIRONMENT
R ITEM OBJECT
RO ITEM
V VIRTUAL SPACE

1. An information processing device comprising:
an estimation unit that estimates an operable part among a plurality of parts of a first object obtained by capturing a real item into a virtual space; and
a display control unit that controls a display device so as to display a motion of the part operated by a second object indicating a virtual item on a basis of operation information of the second object with respect to the first object and a first piece of information indicating a result of the estimation unit.

2. The information processing device according to claim 1,
wherein the display control unit specifies the part of the first object that moves in accordance with the operation information on a basis of the operation information and the first piece of information and controls display of the display device so that the part moves in conjunction with the second object.

3. The information processing device according to claim 2,
wherein the display control unit modifies the part of the first object that moves in accordance with the operation information on a basis of the operation information and the first piece of information and controls display of the display device so that the second object follows the part.

4. The information processing device according to claim 1,
wherein the estimation unit estimates the part of the first object that is movable on a basis of the parts of the first object and a structure of a model that has been machine-learned, and
the first piece of information includes information that enables identification of the operable part estimated by the estimation unit.

5. The information processing device according to claim 4,
wherein the estimation unit estimates the part of the first object as a joint and estimates the operable part of the first object on a basis of the part.

6. The information processing device according to claim 2,
wherein the first piece of information is associated with motion information indicating a motion mode of the first object, and
the display control unit specifies the part of the first object operated by the second object on a basis of the operation information, the first piece of information, and the motion information.

7. The information processing device according to claim 6,
wherein the first piece of information includes information indicating the operable part of the first object in a plurality of the motion modes of the first object, and
the display control unit modifies the part operated by the second object when the motion mode of the first object changes.

8. The information processing device according to claim 3,
wherein, in a case where the part of the first object is modified of a shape and displayed on the display device, the display control unit restores a background image of a portion where the part has been displayed before the modification of the shape.

9. The information processing device according to claim 1,
wherein the estimation unit estimates an operation area in the virtual space related to an operation of the first object, and
the first piece of information includes information related to the operation area estimated by the estimation unit.

10. The information processing device according to claim 1,
wherein the estimation unit estimates an operation mode of the first object on a basis of the parts of the first object and a structure of a model that has been machine-learned, and
the first piece of information associates the operation mode estimated by the estimation unit with the parts.

11. An information processing method by a computer, the method comprising the steps of:
estimating an operable part among a plurality of parts of a first object obtained by capturing a real item into a virtual space; and
controlling a display device so as to display a motion of the part operated by a second object indicating a virtual item on a basis of operation information of the second object with respect to the first object and a first piece of information indicating a result of the estimation.

12. A program for causing a computer to execute the steps of:
estimating an operable part among a plurality of parts of a first object obtained by capturing a real item into a virtual space; and
controlling a display device so as to display a motion of the part operated by a second object indicating a virtual item on a basis of operation information of the second object with respect to the first object and a first piece of information indicating a result of the estimation.
